(19) United States
(12) Patent Application Publication
(10) Pub. No.: US 2013/0255336 A1
(43) Pub. Date: Oct. 3, 2013

(54) LOCK PROTECTION

(71) Applicants: Pratik Desai, Chateauguay (CA); Michel Dallaire, Montreal (CA)

(72) Inventors: Pratik Desai, Chateauguay (CA); Michel Dallaire, Montreal (CA)

(73) Assignee: Societe de Velo en Libre-Service, Lachine (CA)

(21) Appl. No.: 13/431,585

(22) Filed: Mar. 27, 2012

(51) Int. Cl. E05B 17/00

(52) U.S. Cl. 70/431

(57) ABSTRACT

A lock protection for a light vehicle is selectively engageable to a light vehicle docking stand for securing thereto. The lock protection comprises a body selectively covering a lock of the light vehicle. The body is movable with respect to the lock between a first position and a second position. When in the first position the body prevents access to the lock. When in the second position the body allows access to the lock. When the vehicle is disengaged from the docking stand, the body is movable to the second position. When the vehicle is engaged to the docking stand, the body is maintained in the first position by the docking stand. A lock and lock protection assembly is also presented.

### TECHNICAL FIELD

The present relates to protections of locks and more specifically to protections of locks of lights vehicles.

### BACKGROUND

Bicycles that are part of sharing programs are typically locked at various bicycle docking stands (also sometimes referred as ‘bicycle stands’, ‘bicycle racks’, ‘dock points’ or ‘docking stations’). The docking stands can be found at various locations in a city having such sharing program. The docking stands are designed to cooperate only with bicycles of the sharing program. A locking system secures the bicycles to the docking stands. Although the docking stands are placed at locations which are usually convenient to the user, there are situations where the user needs to secure his/her bicycle at places where the docking stands are not available or are prohibitory far away. In those cases, the user uses a flexible cable to temporarily lock, for example, the bicycle to a pole.

The flexible cable is provided with the bicycle upon rental. One end of the bicycle lock is fixedly attached to the bicycle, and another end of the flexible cable is free. The user typically surrounds the pole with the flexible cable and attaches the free end to a lock provided on the bike. The lock includes an aperture (i.e. female portion) that receives the free end of the flexible cable (i.e. male portion). To secure the free end with the flexible cable, the user engages the free end of the flexible cable into the aperture of the lock until it secures thereto. To release the flexible cable, the user uses a key provided with the bicycle upon rental.

When the flexible cable is not in use, it is stored into a space defined between a handlebar and a basket of the bicycle. When the flexible cable is stored, the lock is typically vulnerable to degradations, either environmental or voluntary. Environmental degradations include dirt or water that would clog the aperture of the lock that receives the free end of the flexible cable. Voluntary degradations include chewing gums incrusted in the aperture of the lock.

Such degradations could result in the lock and, therefore, the flexible cable being inoperative, which would cause discomfort to the user, as he/she could not secure his/her bicycle whenever wished.

Therefore, there is a need for a device that would at least decrease some of the degradations undergone by locking mechanisms on light vehicles.

### BRIEF SUMMARY

It is an object of the present to overcome at least some of the inconveniences mentioned above.

In a first aspect, a lock protection for a light vehicle is provided. The light vehicle is selectively engageable to a light vehicle docking stand for securing thereto. The lock protection comprises a body selectively covering a lock of the light vehicle. The body is movable with respect to the lock between a first position and a second position. When in the first position the body prevents access to the lock. When in the second position the body allows access to the lock. When the vehicle is disengaged from the docking stand, the body is movable to the second position. When the vehicle is engaged to the docking stand, the body is maintained in the first position by the docking stand.

In a further aspect, when the vehicle is disengaged from the docking stand, the body is movable to the first position.

In an additional aspect, the lock further comprises a spring. When the vehicle is disengaged from the docking stand, the spring forces the body to the second position.

In a further aspect, the body is a ring, and the lock protection further comprises a flange connected to the ring.

In an additional aspect, when the vehicle is engaged to the docking stand, the flange abuts against the docking stand thereby maintaining the body in the first position.

In a further aspect, when the body is in the first position, the flange is in a first position. When the body is in the second position, the flange is in a second position. The second position of the flange is vertically above the first position of the flange.

In an additional aspect, when the body is in the second position, the aperture of the lock protection is adapted to be aligned with the aperture of the lock. When the body is in the first position, the aperture of the lock protection is adapted to be offset from the aperture of the lock.

In a second aspect, a lock and lock protection assembly for a light vehicle is provided. The light vehicle is selectively engageable to a light vehicle docking stand for securing thereto. The lock and lock protection comprises a lock comprising an aperture. A lock protection comprises a body having an aperture. The body selectively covers the aperture of the lock. The body is movable with respect to the lock between a first position and a second position. When in the first position the body prevents access to the lock. When in the second position the body allows access to the lock. When the vehicle is disengaged from the docking stand, the body is movable to the second position. When the light vehicle is engaged to the docking stand, the body is maintained in the first position by the docking stand.

In a further aspect, when the body is in the second position, the aperture of the lock is aligned with the aperture of the lock protection. When the body is in the first position, the aperture of the lock is offset from the aperture of the lock protection.

In an additional aspect, the lock is cylindrical. The body of the lock protection is a ring disposed around the lock.

In a further aspect, the lock protection further includes a flange connected to the body. When the vehicle is engaged to the docking stand, the flange abuts against the docking stand thereby maintaining the body in the first position.

In an additional aspect, when the body is in the first position, the flange is in a first position. When the body is in the second position, the flange is in a second position. The second position of the flange is vertically above the first position of the flange.

Embodiments of the present can have at least one of the above-mentioned aspects, but do not necessarily have all of them.

Additional and/or alternative features, aspects, and advantages of embodiments of the present will become apparent from the following description, the accompanying drawings, and the appended claims.

### BRIEF DESCRIPTION OF THE DRAWINGS

For a better understanding of the present, as well as other aspects, and further features thereof, reference is made to the following description which is to be used in conjunction with the accompanying drawings, where:

FIG. 1 is a perspective view taken from a rear, right side of a bicycle and a docking stand;

FIG. 2 is a perspective view taken from a top front, right side of a frame of the bicycle of FIG. 1;

FIG. 3 is a perspective view taken from a top rear, right side of a basket of the bicycle of FIG. 1;

FIG. 4 is a perspective view taken from a bottom, rear, left side of a lock and lock protection of the bicycle of FIG. 1;

FIG. 5 is an exploded view of the lock and lock protection of FIG. 4;

FIG. 6 is a close-up view of a front of the bicycle of FIG. 1 showing the lock protection of FIG. 4 in a first position; and

FIG. 7 is a close-up view of the front of the bicycle and the docking stand of FIG. 1 showing the lock protection of FIG. 4 in a second position.

### DETAILED DESCRIPTION

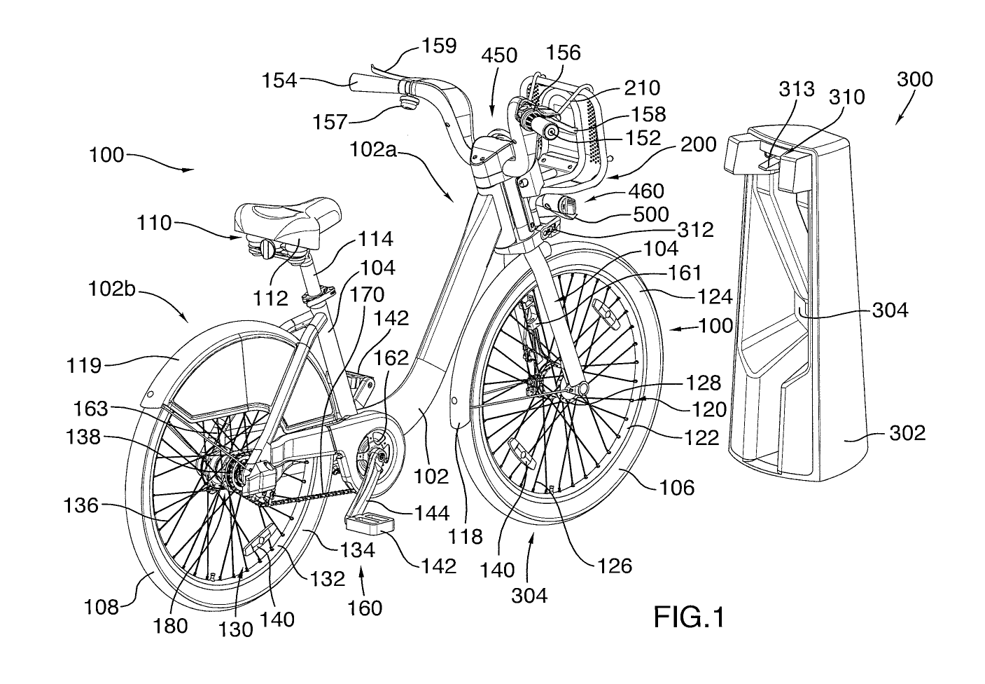

Referring to FIG. 1, a pedal powered bicycle 100 having a lock protection 500 will be described. Although the lock protection 500 will be described herein in association with the bicycle 100, it is contemplated that other types of light vehicles (motorized or not, having one or more wheels or track) could be used. For example, a motorcycle or a scoot bike could be used. Furthermore, it should be understood that the term ‘pedal powered’ is not limited to vehicles powered exclusively by pedaling but that it also comprises vehicles provided with both pedals and motors such as Velosolex™ and mopeds.

The bicycle 100 is part of a bicycle sharing program that enables a user to rent a bicycle. The bicycle sharing program includes a bicycle kiosk (not shown) which manages the renting of the bicycles 100. Each bicycle 100 cooperates with any one of a plurality of docking stands 300 (only one being shown in FIG. 1) associated with the bicycle kiosk. Several associations of the bicycle kiosk and the plurality of docking stands 300 are disposed at various locations throughout an area having such bicycle sharing program. The different locations enable the user to rent the bicycle 100 at one location and drop it at another location. The docking stand 300 will be described in more detail below.

The bicycle 100 comprises a hollow frame 102, front 106 and rear 108 wheels connected to front 102a and rear 102b of the frame 102 respectively, a seat assembly 110 mounted onto the rear 102b of the frame 102 and a handlebar 150 mounted onto the front 102a of the frame 102. It is contemplated that some or all of the front wheels 106, rear wheels 108 and seat assembly 110 could be removably connected to the frame 102.

The frame 102 which will be described in greater detail below is connected at the front 102a to a fork assembly 104. The fork assembly 104 receives therebetween the front wheel 106. The fork assembly 104 is made of an aluminum alloy and is hollow. It is contemplated that the fork assembly 104 could be fixed to the frame 102. It is also contemplated that the fork assembly 104 could be plain and made of a material other than an aluminum alloy. For example, the fork assembly 104 could be made of plastic.

Each of the front and rear wheel 106, 108 includes a corresponding front and rear wheel frame 122, 132 and a corresponding front and rear tire 124, 134. Although the tires 124, 134 are shown in the Figures to be adapted for road use, it is contemplated that the tires 124, 134 could be off-road tires. The front wheel frame 122 is connected to the fork assembly 104 by a front hub 128. A plurality of spokes 126 extends between the front hub 128 and the front wheel frame 122. Similarly, the rear wheel frame 132 is connected to the rear 102b of the frame 102 by a rear hub 138, and a plurality of spokes 136 extends between the rear hub 138 and the rear wheel frame 132. Reflective panels 140 are disposed onto the spokes 126, 136. The reflective panels 140 reflect light which helps the bicycle 100 to signal its presence. The front and rear wheels 106, 108 are each protected by front and rear wheel protectors 118, 119. It is contemplated that the reflective panels 140 and/or the front and rear wheel protectors 118, 119 could be different than shown in the Figures. It is also contemplated that the reflective panels 140 and/or the front and rear wheel protectors 118, 119 could be omitted.

The handlebar 150 allows the user to steer the bicycle 100. The handlebar 150 comprises a right handle 152 and a left handle 154 each adapted to be gripped by a hand of the user. The handlebar 150 is operatively connected to the front wheel 106 so that when the user rotates the handlebar 150 clockwise, the front wheel 106 rotates towards the right hand side, and the bicycle 100 steers right. Similarly, when the user rotates the handlebar 150 counter clockwise, the front wheel 106 rotates towards the left hand side, and the bicycle 100 steers left. The right handle 152 includes a gear shifter 156 and a front brake lever 158. The left handle 154 includes a rear brake lever 159 and a bell 157. The front brake lever 158 activates a front brake 161, and the rear brake lever 159 activates a rear brake 163. The handlebar 150 is hollow and houses cables operatively connecting the front and rear brake levers 156, 159 to the front and rear brakes 161, 163. It is contemplated that the handlebar 150 could include more or less features than recited above. The front and rear brakes 161, 163 will be described below.

The bicycle 100 is propelled via left and right pedals 142 disposed below the seat assembly 110. The user typically disposes each of his/her feet onto the pedals 142. A drive assembly 160 is connected to the pedals 142 by left and right crank arms 144. The drive assembly 160 includes a sprocket 162 operatively coupled to the rear wheel 108 by a chain 170 extending therebetween. To propel the bicycle 100, the user pushes onto the pedals 142 so as to initiate a rotation of the pedals 142. The rotation of the pedals 142 rotates the sprocket 162 which moves the chain 170 and transmits power to the rear wheel 108. The drive assembly 160 includes other components typical of drive assemblies for bicycles which will not be described herein. It is contemplated that the pedals 142 could have feet guards.

A gear shifting unit 180 allows the user to shift gears. The gear shifting unit 180 is mounted to the frame 102 near the rear hub 138. The gear shifting unit 180 is actuated by the user via the gear shifter 156 located on the right handle 152. The gear shifter 156 and the gear shifting unit 180 are connected together by a gear cable (not shown) disposed inside the frame 102 which, as mentioned above, is hollow. The gear shifting unit 180 is a typical gear shifting unit for bicycles and will not be described in greater details. When the user desires to change gears, he/she operates the gear shifter 156, which via the cable changes a position of the gear shifting unit 180.

The front brake 161 is connected to the front wheel 106 near the front hub 162. The rear brake 163 is connected to the rear wheel 108 near the rear hub 172. The front and rear brakes 161, 163 are typical brakes for bicycles and will not be described in details herein. It is contemplated that the bicycle 100 could have only the front brake 161 or only the rear brake 163.

The seat assembly 110 includes a seat 112 connected to a seat post 114. The seat post 114 is slideably engaged into a seat tube (not shown) for adjusting a height of the seat 112. The seat tube is fixedly connected to a seat tube 104 of the frame 102. The seat post 114 is connected to a seat-anti theft system (not shown). It is contemplated that the bicycle 100 could not have the seat-anti theft system.

A basket 200 is disposed at a front of the bicycle 100. The basket 200 allows the user to dispose items (not shown) therein and to carry them during a bicycle trip for example. The basket 200 will be described below.

It is contemplated that the bicycle 100 could comprise one or more lights to help signal the presence of the bicycle 100. The lights could be operatively connected to a power source via a dynamo or a battery. It is also contemplated that the bicycle 100 could include other features typical of such vehicles.

Still referring to FIG. 1, the bicycle 100 features an electronic lock which is used to lock the bicycle 100 to the docking stands 300. The electronic lock includes a male portion 312 disposed on a front of the bicycle 100 and a female portion 313 disposed on the docking stand 300. When a user engages the bicycle 100 into any one of the docking stands 300, the male portion 312 engages with the female portion 313 and the electronic lock is locked. To unlock the electronic lock, the user uses a key (in the shape of a card) of the bicycle sharing program. An embodiment of the locking system is described in the United States Patent Publication Serial No. 2009/0266673 by Dallaire et al., incorporated herein by reference. It is also contemplated that the user could unlock the bicycle 100 by way other than using the key. For example, the user could use a code.

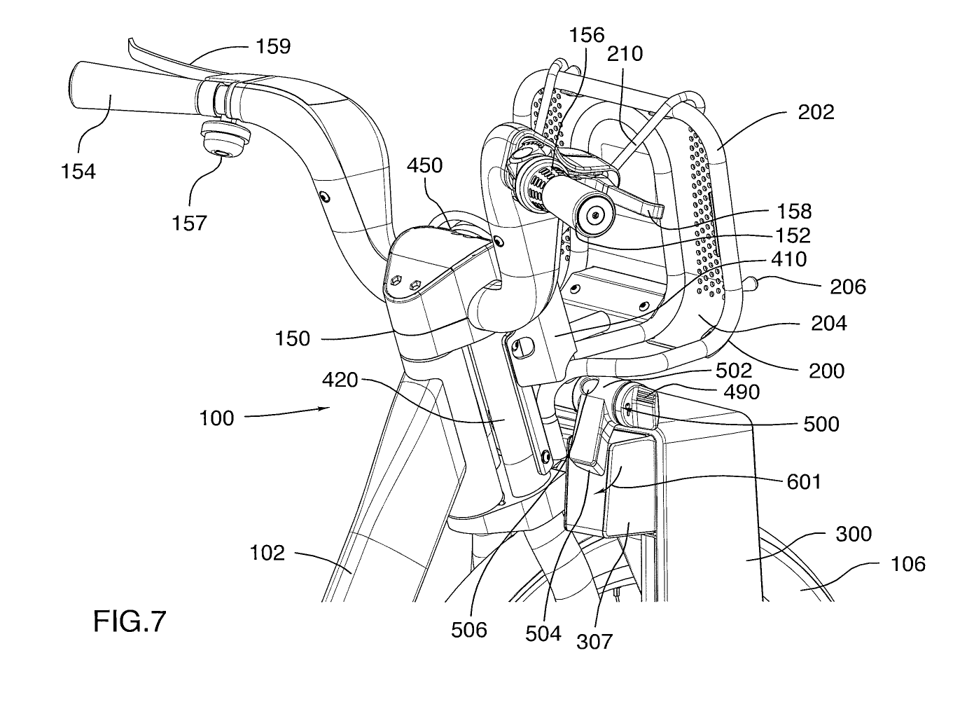

The docking stand 300 includes an upright post 302 having a vertical indentation 304. The vertical indentation 304 receives a front portion of the front wheel 106 when the bicycle 100 is locked to the docking stand 300 (partially shown in FIG. 7). The docking stand 300 includes the female portion 313 of the locking system. It is contemplated that the docking stand 300 could have a shape other than the one shown in the Figures. The shape of the docking stand 300 could for example depend on where the male portion 312 is mounted to the bicycle 100. Also, the docking stand 300 could have various shapes depending on the type of bicycle it receives.

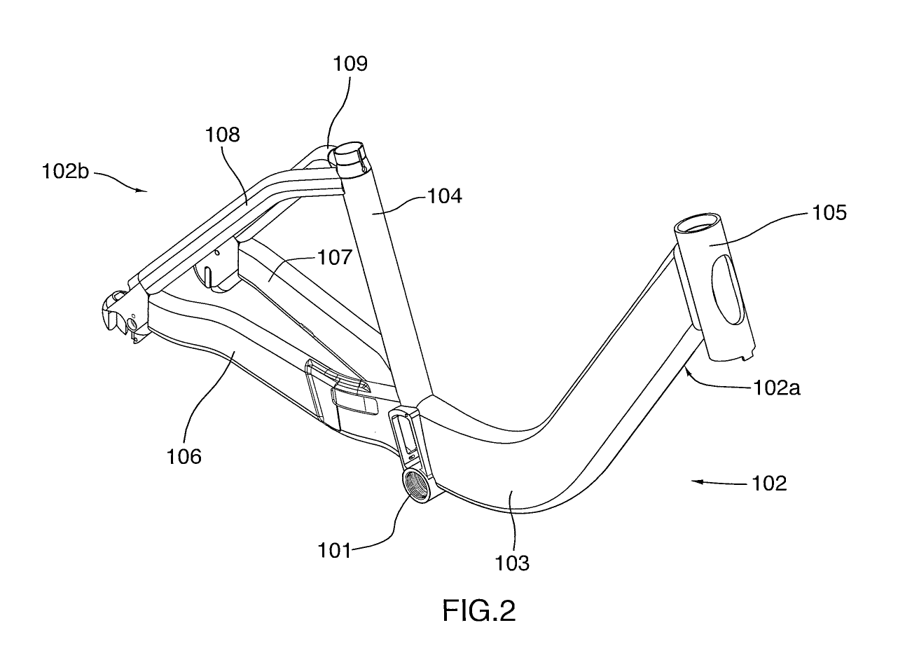

Referring now to FIG. 2, the hollow frame 102 comprises a hollow down tube 103, the hollow seat tube 104 and a pair of hollow left and right chain stays 106, 107. The down tube 103, the seat tube 104 and the chain stays 106, 107 are connected to each other by a hollow bottom bracket shell assembly 101. The bracket shell assembly 101 connects to the pedals 162. The hollow frame 102 further comprises a pair of left and right seat stays 108, 109 connecting the seat tube 104 to the chain stays 106, 107.

The hollow down tube 103, the hollow seat tube 104, the chain stays 106, 107 and the seat stays 108, 109 are each made of an aluminum alloy. It is contemplated that the hollow frame 102 could be made of a material other than an aluminum alloy. For example, the hollow frame 102 could be made of an alloy having at least one of aluminum, magnesium, titanium or the like. In another example, the frame 102 is made of carbon fiber, fiberglass or a thermoplastic such as polyvinyl chloride, polypropylene, acrylonitrile butadiene styrene or polycarbonate. It is contemplated that the hollow down tube 103, the hollow seat tube 104, the chain stays 106, 107 and the seat stays 108, 109 could be made of material different from each other.

The down tube 103 has a generally oval cross-section defining a box beam profile. A shape of the cross-section is chosen so that the weight of the user riding the bicycle 100 do not strain and deform the down tube 103. It is contemplated that the down tube 103 could have a cross-section other than an oval cross-section. For example, the down tube 103 may have a generally circular, square or rectangular cross-section. The down tube 103 connects to the handlebar 150 and the fork assembly 104 at a front 105 thereof.

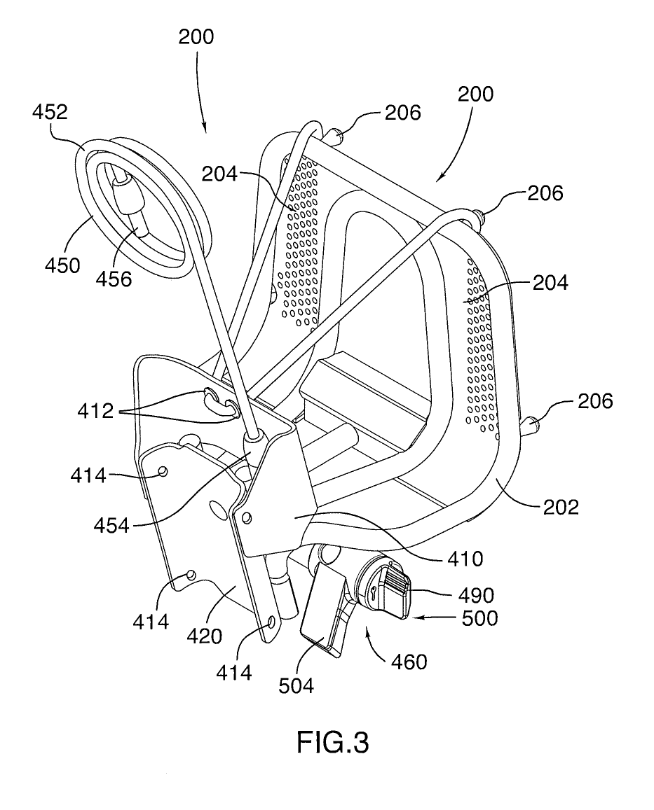

Turning now to FIG. 3, the basket 200 includes a basket frame 202 and basket panels 204. The basket frame 202 is made of hollow aluminum tubes, and the basket panels 204 of perforated aluminum sheets. The basket panels 204 are welded to the basket frame 202. The basket 200 forms a L-shape, leaving left and right side exposed. A front of the basket 200 has a plurality of protrusions 206. It is contemplated that the basket 200 could be made of a material other than aluminum. For example, the basket 200 could be made of plastic. It is also contemplated that the basket 200 could be formed differently from basket frame and basket panels. For example, the basket panels 204 could be omitted. In another example, the basket frame 202 is two or more sheets instead of tubes. It is also contemplated the basket panels 204 could not be perforated. It is contemplated that the basket frame 202 and basket panels 204 could be integrally formed. It is also contemplated that the basket 200 could have a shape different from a L-shape. For example, the basket 200 could have a U-Shape or could right and left walls. It is also contemplated that the protrusions 206 could be omitted. It is contemplated that the protrusions 206 could have a shape different from the one shown in the Figures. For example, the protrusions 206 could be hooks. It is also contemplated that the protrusions 206 could be disposed in a fashion different from shown in the Figures.

A bungee cord 210 extends across a top of the basket 200. The bungee cord 210 helps to retain the items that may be placed in the basket 200. The bungee cord 210 is connected to a first bracket 410. The first bracket 410 has two apertures 412 which receive the bungee cord 210. The bungee cord 210 is removably engaged with the protrusions 260 of the basket 200. Positions of the protrusions 260 allow different positions of the bungee cord 210 which in turn allow to accommodate items of different sizes. It is contemplated that the bungee cord 210 could be omitted. It is contemplated that more than one bungee cord 210 could be provided on the bicycle 100. It is also contemplated that the first bracket 410 could not receive the bungee cord 210.

The basket 200 is connected to the fork assembly 104 via a second bracket 420. The second bracket 420 is screwed to the handlebar 150 at points 414 and is welded the basket frame 202. The first bracket 410 is screwed to the handlebar 150 with the second bracket 420 at the points 414. The first bracket 410 is disposed vertically above and forward of the second bracket 420. A space 416 created between the first bracket 410 and the second bracket 420 allows to store a flexible cable lock 450. The flexible cable lock 450 will be described below. It is contemplated that the second bracket 420 could be welded to the fork assembly 104 instead. It is also contemplated that the first bracket 410 could be welded to the second bracket 420. It is also contemplated that the first bracket 410 could not be forward of the second bracket 420. It is also contemplated that the first bracket 410 and the second bracket 420 could be integrally formed together to form a single bracket. It is contemplated that the first bracket 410 could be omitted. It is contemplated that the first bracket 410 could have a shape different from the one shown in the Figures. For example, the first bracket 410 could be larger than shown in the Figures.

The flexible cable lock 450 includes a cable body 452, a first end 454 fixed to the bicycle 100 and a second end 456 free. The cable body 452 is a metal cable covered with plastic and flexible enough to allow the cable lock 450 to be positioned in different ways. The cable lock 450 is used to secure the bicycle 100 at locations where the docking stands 300 are not available. The cable lock 450 can, for example, be disposed around a pole to secure the bicycle 100 to the pole. The free end 456 is selectively received in a lock 460. It is contemplated that the cable lock 450 could have the first end 454 free from the bicycle 100.

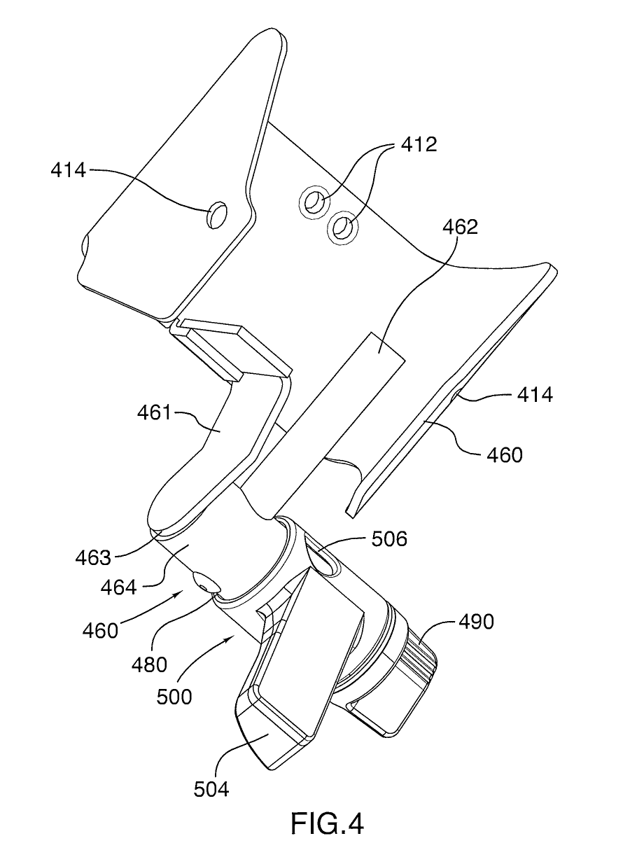

Turning now to FIGS. 4 to 7, the lock 460 and lock protection 500 will be described.

Referring more specifically to FIG. 4, the lock 460 is disposed vertically below the basket 200. The lock 460 is connected to the bicycle 100 via a bracket 461 and a tube 462. The bracket 461 is welded to the first bracket 410 and to an end 463 of a casing 464 of the lock 460. The tube 462 is welded to the first bracket 410 and to the casing 464. It is contemplated that the lock 460 could be disposed elsewhere on the bicycle 100. For example, the lock 460 could be disposed on the fork assembly 104. It is also contemplated that the lock 460 could be connected to the bicycle 100 in other ways. For example, the lock 460 could be screwed to the frame 102. It is also contemplated that the tube 462 could be replaced by a bracket.

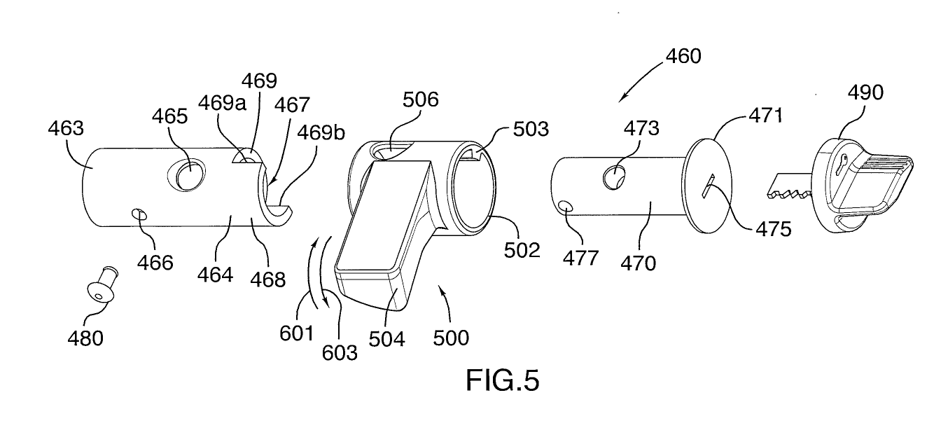

As best shown in FIG. 5, the casing 464 has apertures 465 and 466 on a side wall thereof, and an aperture 467 on a top thereof. The aperture 465 selectively receives the second end 456 of the cable lock 450. The aperture 466 receives a screw 480. As mentioned above, the end 463 of the casing 464 is closed as it is welded to the bracket 461. An other end 468 of the casing 464 is open and has an indentation 469. The indentation is defined by walls 469a and 469b. It is contemplated that the indentation 469 could be replaced by a slot or by two outward extending walls.

The lock 460 further includes a lock barrel 470 slideably engaged in the casing 464 and retained inside the casing 464 by a flange 471 at one end thereof. The lock barrel 470 has an aperture 473 aligned on a side wall thereof with the aperture 465 of the casing 464 to selectively receive the second end 456 of the cable lock 450. The lock barrel 470 has an aperture 475 which selectively receives a key 490. The lock barrel 470 has an aperture 477 on the side wall thereof which selectively receives the screw 480.

The key 490 is used to unlock the second end 456 from the lock 460. When the cable lock 450 is not in use, the key 490 is retained by the lock 460. When the user desires to use the cable lock 450, he/she inserts the second end 456 of the cable lock 450 inside the apertures 465, 473, the key 490 becomes unlocked from the lock 460, and the second end 456 of the cable lock 450 becomes retained by the lock 460. It is contemplated that the key 490 could be free from the lock 460 even when the second end 456 is removed from the lock 460. It is also contemplated that the lock 460 could have a way to secure the cable lock 450 to the lock 460 using something else than the key 490. For example, a code could be used.

The lock protection 500 includes a ring 502 and a flange 504. The ring 502 is engaged around the casing 464. The ring 502 has a tooth 503 extending radially inwardly therefrom. The tooth 503 is received in the indentation 469. Upon rotating the lock protection 500 relative to the casing 464 (arrows 601, 603), the tooth 503 travels in the indentation 469 between the walls 469a, 469b. The walls 469a, 469b thus define maximum and minimum positions of the lock protection 500 relative to the casing 464. The lock protection 500 further includes an aperture 506 which, as will be described below, is in selective alignment with the apertures 465, 473. It is contemplated that the lock protection 500 could be shaped differently. For example, the flange 504 could be shorter, or could be disposed at an angle with respect to the ring 502 different than shown in the Figures.

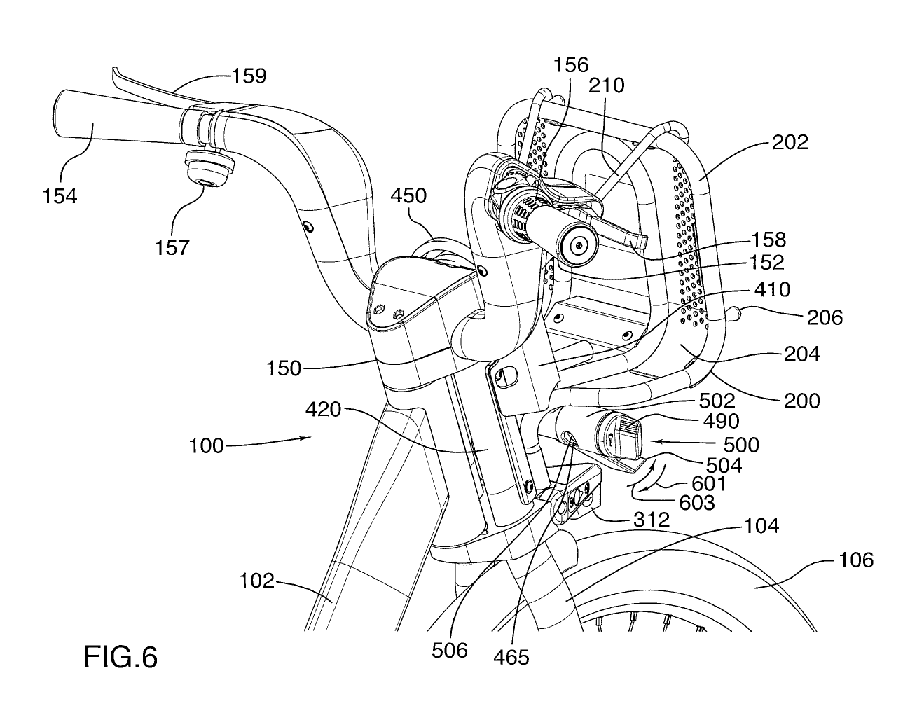

Turning now to FIGS. 6 and 7, an operation of the lock protection 500 will be described.

Referring to FIG. 6, when the bicycle 100 is in use, disengaged from the docking stand 300, the lock protection 500 can be moved (arrows 601 and 603) to an open position. In the open position, the aperture 506 of the lock protection 500 is aligned with the aperture 465 of the lock 460. In the open position, the free end 456 of the cable lock 450 can be inserted in the aperture 465. When the bicycle 100 is in use, disengaged from the docking stand 300, the lock protection 500 can be moved to positions other than the first position, where the lock protection 500 covers partially or totally the aperture 465 of the lock 460. This could be the case for example, when the user does not use the cable 450, yet desires to protect the lock 460. It is contemplated that when the bicycle 100 is in use, the lock protection 500 could be positioned by default to the open position. This could for example be achieved by spring loading the lock protection 500.

Referring to FIG. 7, when the bicycle 100 is not in use, the user engages the bicycle 100 with the docking stand 300. Upon inserting the front wheel 106 into the vertical indentation 304 of the docking stand 300, the flange 504 of the lock protection 500 abuts a protrusion 307 of the docking stand 300 and is moved in the direction of the arrow 601 until the tooth 503 abuts the wall 469b of the indentation 469. The lock protection 500 rotating relative to the lock 460 forces the lock protection 500 to be in a closed position. In the closed position, the aperture 506 of the lock protection 500 is not aligned with the aperture 465 of the lock 460, and the lock protection 500 covers the aperture 465 of the lock 460. In the closed position, the free end 456 of the flexible cable 450 cannot be inserted in the aperture 465. When the bicycle 100 is engaged with the docking stand 300, the lock protection 500 cannot be moved to positions other than the closed position since the tooth 503 abuts the wall 469b of the indentation 469. It is contemplated, however, that when the bicycle 100 is engaged with the docking stand 300, the lock protection 500 could be moved to positions other than the position shown in FIG. 7, as long as the lock protection 500 covers the aperture 465 of the lock 460.

Modifications and improvements to the above-described embodiments of the present may become apparent to those skilled in the art. The foregoing description is intended to be exemplary rather than limiting. The scope of the present is therefore intended to be limited solely by the scope of the appended claims.

What is claimed is:

1. A lock protection for a light vehicle, the light vehicle being selectively engageable to a light vehicle docking stand for securing thereto, the lock protection comprising:
a body selectively covering a lock of the light vehicle, the body being movable with respect to the lock between a first position and a second position, when in the first position the body preventing access to the lock, when in the second position the body allowing access to the lock,
when the vehicle is disengaged from the docking stand, the body being movable to the second position, and
when the vehicle is engaged to the docking stand, the body being maintained in the first position by the docking stand.

2. The lock protection of claim 1, wherein when the vehicle is disengaged from the docking stand, the body being movable to the first position.

3. The lock protection of claim 1, wherein the lock further comprises a spring,
when the vehicle is disengaged from the docking stand, the spring forces the body to the second position.

4. The lock protection of claim 1, wherein the body is a ring, and the lock protection further comprises a flange connected to the ring.

5. The lock protection of claim 4, wherein when the vehicle is engaged to the docking stand, the flange abuts against the docking stand thereby maintaining the body in the first position.

6. The lock protection of claim 4, wherein when the body is in the first position, the flange is in a first position;
when the body is in the second position, the flange is in a second position; and
the second position of the flange is vertically above the first position of the flange.

7. The lock protection of claim 1, wherein when the body is in the second position, the aperture of the lock protection is adapted to be aligned with the aperture of the lock; and
when the body is in the first position, the aperture of the lock protection is adapted to be offset from the aperture of the lock.

8. A lock and lock protection assembly for a light vehicle, the light vehicle being selectively engageable to a light vehicle docking stand for securing thereto, the lock and lock protection comprising:
a lock comprising an aperture; and
a lock protection comprising:
a body having an aperture, the body selectively covering the aperture of the lock, the body being movable with respect to the lock between a first position and a second position, when in the first position the body preventing access to the lock, when in the second position the body allowing access to the lock,
when the vehicle is disengaged from the docking stand, the body being movable to the second position, and
when the light vehicle is engaged to the docking stand, the body being maintained in the first position by the docking stand.

9. The lock and lock protection assembly of claim 8, wherein when the body is in the second position, the aperture of the lock is aligned with the aperture of the lock protection; and
when the body is in the first position, the aperture of the lock is offset from the aperture of the lock protection.

10. The lock and lock protection assembly of claim 8, wherein the lock is cylindrical; and
the body of the lock protection is a ring disposed around the lock.

11. The lock and lock protection assembly of claim 8, wherein the lock protection further includes a flange connected to the body;
when the vehicle is engaged to the docking stand, the flange abuts against the docking stand thereby maintaining the body in the first position.

12. The lock and lock protection assembly of claim 8, wherein when the body is in the first position, the flange is in a first position;
when the body is in the second position, the flange is in a second position; and
the second position of the flange is vertically above the first position of the flange.
